(19) United States
(12) Patent Application Publication
(10) Pub. No.: US 2026/0227271 A1
(43) Pub. Date: Aug. 6, 2026

(54) A SYSTEM AND METHOD FOR WATER USAGE MONITORING, LEAK DETECTION, BACKFLOW DETECTION, AND METER HEALTH

(71) Applicant: KAPTECH WATER SUBMETERING LLC., Beachwood, OH (US)

(72) Inventors: Jonathan B. KAPLAN, Beachwood, OH (US); Alan Jonathan MAKALSKY, Beachwood, OH (US)

(73) Assignee: KAPTECH WATER SUBMETERING LLC., Beachwood, OH (US)

(21) Appl. No.: 19/148,921

(22) PCT Filed: Jan. 18, 2024
(86) PCT No.: PCT/US2024/011962

§ 371 Date: Jul. 17, 2025

Related U.S. Application Data
(60) Provisional application No. 63/439,691, filed on Jan. 18, 2023.

(51) Int. Cl. G01M 3/28; G01F 15/063; G01M 3/00

(52) U.S. Cl. CPC G01M 3/2807; G01F 15/063; G01M 3/007

(57) ABSTRACT

A system and method for providing monitoring of water usage, monitoring of meter health, providing leak detection, and providing backflow detection. The system includes receiving measurement data corresponding to water usage from an associated meter device over a communications network, and analyzing the received measurement data to determine at least one property associated with the water usage. A graphical user interface is then generated depicting the property associated with the water usage based on the analysis. The generated graphical user interface is then selectively communicated to a client device.

### CROSS-REFERENCE TO RELATED APPLICATIONS

This application claims the benefit of U.S. Provisional Patent Application Ser. No. 63/439,691, filed Jan. 18, 2023 and titled “A SYSTEM AND METHOD FOR WATER USAGE MONITORING, LEAK DETECTION, AND METER HEALTH”, the disclosure of which is incorporated by reference in its entirety herein.

### BACKGROUND

This disclosure relates to systems and methods that provide monitoring of water usage, monitoring of meter health, and providing leak and backflow detection.

### BRIEF DESCRIPTION OF THE DRAWINGS

Aspects of the present disclosure are best understood from the following detailed description when read with the accompanying figures. It is noted that, in accordance with the standard practice in the industry, various features are not drawn to scale. In fact, the dimensions of the various features may be arbitrarily increased or reduced for clarity of discussion.

FIG. 1 illustrates a system for monitoring water usage in accordance with one embodiment.

FIG. 2 is an illustrative diagram of a meter utilized in the system for monitoring water usage in accordance with one embodiment.

FIG. 3 is a diagram illustrating a flow diagram of the system for monitoring water usage in accordance with one embodiment.

FIG. 4 is an illustrative diagram of a hierarchical zone structure in accordance with some embodiments.

FIG. 5 is an illustrative view of a dashboard graphical user interface display in accordance with some embodiments.

FIG. 6 is an illustrative example of a water usage graphical format in accordance with some embodiments.

FIG. 7 is a flowchart illustrating a method for water usage monitoring and meter health in accordance with some embodiments.

### DETAILED DESCRIPTION

The following disclosure provides many different embodiments, or examples, for implementing different features of the provided subject matter. Specific examples of components and arrangements are described below to simplify the present disclosure. These are, of course, merely examples and are not intended to be limiting. For example, the formation of a first feature over or on a second feature in the description that follows may include embodiments in which the first and second features are formed in direct contact, and may also include embodiments in which additional features may be formed between the first and second features, such that the first and second features may not be in direct contact. In addition, the present disclosure may repeat reference numerals and/or letters in the various examples. This repetition is for the purpose of simplicity and clarity and does not in itself dictate a relationship between the various embodiments and/or configurations discussed.

Further, spatially relative terms, such as “beneath,” “below,” “lower,” “above,” “upper” and the like, may be used herein for ease of description to describe one element or feature's relationship to another element(s) or feature(s) as illustrated in the figures. The spatially relative terms are intended to encompass different orientations of the device in use or operation in addition to the orientation depicted in the figures. The apparatus may be otherwise oriented (rotated 90 degrees or at other orientations) and the spatially relative descriptors used herein may likewise be interpreted accordingly.

In the following description, certain specific details are set forth in order to provide a thorough understanding of various embodiments of the disclosure. However, one skilled in the art will understand that the disclosure may be practiced without these specific details. In other instances, well-known structures associated with electronic components and fabrication techniques have not been described in detail to avoid unnecessarily obscuring the descriptions of the embodiments of the present disclosure.

Unless the context requires otherwise, throughout the specification and claims that follow, the word “comprise” and variations thereof, such as “comprises” and “comprising,” are to be construed in an open, inclusive sense, that is, as “including, but not limited to.”

The use of ordinals such as first, second and third does not necessarily imply a ranked sense of order, but rather may only distinguish between multiple instances of an act or structure.

Reference throughout this specification to “one embodiment” or “an embodiment” means that a particular feature, structure or characteristic described in connection with the embodiment is included in at least one embodiment. Thus, the appearances of the phrases “in one embodiment” or “in an embodiment” in various places throughout this specification are not necessarily all referring to the same embodiment. Furthermore, the particular features, structures, or characteristics may be combined in any suitable manner in one or more embodiments.

As used in this specification and the appended claims, the singular forms “a,” “an,” and “the” include plural referents unless the content clearly dictates otherwise. It should also be noted that the term “or” is generally employed in its sense including “and/or” unless the content clearly dictates otherwise.

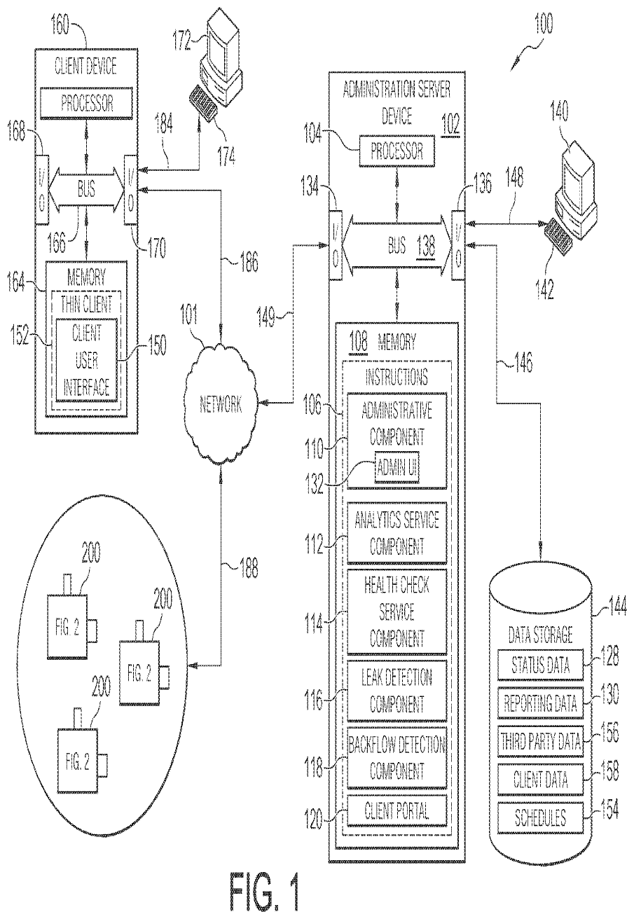

Turning now to FIG. 1, there is shown an illustrative diagram of a system 100 for water usage and meter monitoring in accordance with one embodiment of the subject application. It will be appreciated that the various components depicted in FIG. 1 are for purposes of illustrating aspects of the exemplary embodiment, and that other similar components, implemented via hardware, software, or a combination thereof, are capable of being substituted therein.

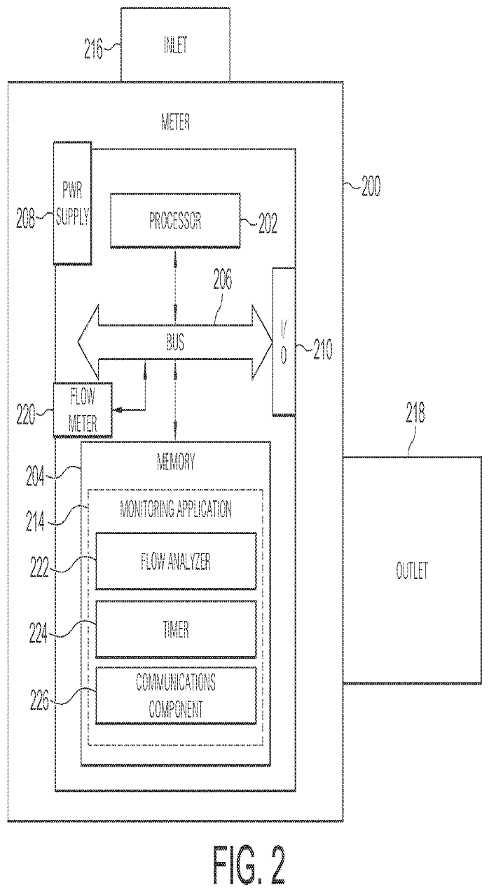

As shown in FIG. 1, the water usage and meter monitoring system 100 includes an administrative server device 102 (hereinafter server 102) configured to interact with a plurality of different devices and components, as are illustrated therein. The system 100 further includes at least one client device 160 in communication with the server 102 via a suitable communications network 101 (as discussed in greater detail below). In addition, the water usage and meter monitoring system 100 further includes one or more meters 200 representative of a variety of remote communication-enabled utility metering devices, e.g., gas, electric, water, etc., device manufacturers, software platforms, and the like. Additional description of the meter devices 200 is provided below with respect to FIG. 2.

In accordance with some embodiments, prior to operating the system 101, an administrative user, via the server 102, registers one or more meter devices 200. For each registered meter device 200, the system 102 records its identifier, address, apartment number, provider information, meter-specific information, device model, and other relevant identification and communication information.

Next, a user, via the client device 160 (or via communication to the server 102) uploads a list of addresses or meter devices 200 to be monitored. In some embodiments, the user, via the client device 160, may specify a frequency of meter monitoring, e.g., every 5 minutes, 10 minutes, 15 minutes, etc. One or more lists may be uploaded, with separate monitoring schedules for each.

In some embodiments, the server 102 may be configured to report results via a web-based user interface, i.e., the client user interface 150. Via the client user interface 150, a client user may view current and historical usage from selected meter devices 200. The client user interface 150 enables the client device 160 to retrieve reports for one or more meter devices 200, for any date range or time range specified.

The exemplary server 102 includes a processor 104, which performs the exemplary method by execution of processing instructions 106 that are stored in memory 108 connected to the processor 104, as well as controlling the overall operation of the computer system 102.

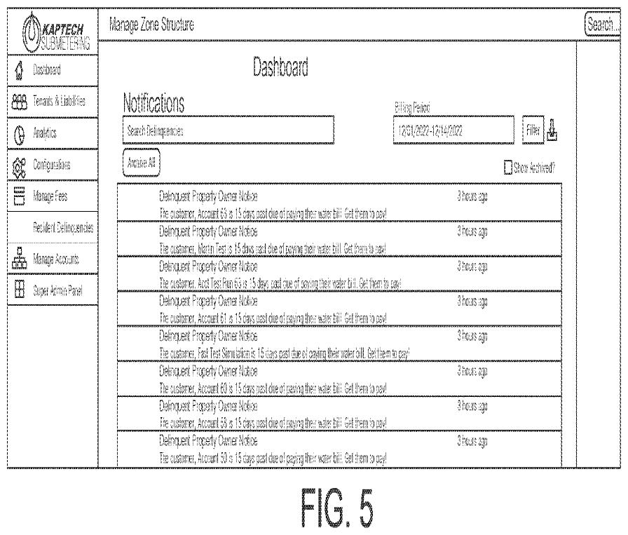

The instructions 106 include an administrative component 110 that is configured to generate an administrative user-interface 132 accessible by a system administrator. In some embodiments, the administrative user-interface 132 generated by the administrative component 110 provides a dashboard, e.g., textual or graphical user interface, for registering and managing devices, e.g., client devices 160, meter devices 200, etc., allowing for system monitoring, etc. FIG. 5 provides an illustrative view of one dashboard display in accordance with varying embodiments disclosed herein.

The instructions 106 stored in memory 108 further include an analytics service component 112 configured to gather results of data received from meter devices 200. The analytics service component 112 may further be configured to modify the received data from the meter devices 200 into a suitable efficient format for querying and reporting.

As illustrated in FIG. 1, the instructions 106 also store a health check service component 114 configured to monitor the health of each meter device 200. In some embodiments, the health check service component 114 may be configured to gather data relating to connectivity checks at regular intervals, power supply status (e.g., battery status), flow meter status, error reporting, etc., as well as to provide such data to the administrative component 110.

The instructions 106 also include a leak detection component 116, configured to periodically check usage data received from meter devices 200 to determine whether a leak is present. In some embodiments, the leak detection component 116 receives historical data on water usage and compares such historical data with current water usage data to infer whether a leak is present. In such embodiments, a correlation between the historical water usage data and the present water usage data may be used to determine whether a leak is present.

The instructions 106 stored in memory 108 may also include a backflow detection component 118 configured to detect a backflow from usage data received from meter devices 200 to determine whether a backflow incident has occurred. The instructions 106 stored in memory 108 may further include a client portal component 120 configured to host a client portal accessible by an associated client device 160, a tenant device 300, or the like, via the network 101.

The various components of the server device 102 may all be connected by a data/control bus 138. The processor 104 of the server device 102 is in communication with an associated data storage 144 via a link 146. A suitable communications link 146 may include, for example, the public switched telephone network, a proprietary communications network, infrared, optical, or other suitable wired or wireless data communications. The data storage 144 is capable of implementation on components of the server device 102, e.g., stored in local memory 108, i.e., on hard drives, virtual drives, or the like, or on remote memory accessible to the server device 102.

The associated data storage 144 corresponds to any organized collections of data (e.g., meter information, status information, third party provider information, labels, scheduling information, client information, user interface information, monitoring programs/applications, user information, logs, reports, etc.) used for one or more purposes. Implementation of the associated data storage 144 is capable of occurring on any mass storage device(s), for example, magnetic storage drives, a hard disk drive, optical storage devices, flash memory devices, a cloud based system, or a suitable combination thereof. The associated data storage 144 may be implemented as a component of the server device 102, e.g., resident in memory 108, or the like. In one embodiment, the associated data storage 144 may include data corresponding to reporting data 130, status data 128, client data 158, third party data 156, schedules 154, and the like.

The server device 102 may include one or more input/output (I/O) interface devices 134 and 136 for communicating with external devices. The I/O interface 134 may communicate, via communications link 148, with one or more of a display device 140, for displaying information, such estimated destinations, and a user input device 142, such as a keyboard or touch or writable screen, for inputting text, and/or a cursor control device, such as mouse, trackball, or the like, for communicating user input information and command selections to the processor 104.

It will be appreciated that the system 100 is capable of implementation using a distributed computing environment, such as a computer network or cloud-based computing platform, which is representative of any distributed communications system capable of enabling the exchange of data between two or more electronic devices. It will be further appreciated that such a computer network includes, for example and without limitation, a virtual local area network, a wide area network, a personal area network, a cellular network, a local area network, the Internet, an intranet, or the any suitable combination thereof. Accordingly, such a computer network comprises physical layers and transport layers, as illustrated by various conventional data transport mechanisms, such as, for example and without limitation, Token-Ring, Ethernet, or other wireless or wire-based data communication mechanisms. Furthermore, while depicted in FIG. 1 as a networked set of components, the system and method are capable of implementation on a stand-alone device adapted to perform the methods described herein.

The server device 102 may include a computer server, workstation, personal computer, cellular telephone, tablet computer, pager, combination thereof, or other computing device capable of executing instructions for performing the exemplary method.

According to one example embodiment, the server device 102 includes hardware, software, and/or any suitable combination thereof, configured to interact with an associated user, a networked device, networked storage, remote devices, or the like.

The memory 108 may represent any type of non-transitory computer readable medium such as random access memory (RAM), read only memory (ROM), magnetic disk or tape, optical disk, flash memory, or holographic memory. In one embodiment, the memory 108 comprises a combination of random access memory and read only memory. In some embodiments, the processor 104 and memory 108 may be combined in a single chip. The network interface(s) 134, 136 allow the computer to communicate with other devices via a computer network, and may comprise a modulator/demodulator (MODEM). Memory 108 may store data the processed in the method as well as the instructions for performing the exemplary method.

The digital processor 104 can be variously embodied, such as by a single core processor, a dual core processor (or more generally by a multiple core processor), a digital processor and cooperating math coprocessor, a digital controller, or the like. The digital processor 104, in addition to controlling the operation of the server device 102, executes instructions 106 stored in memory 108 for performing the method described herein.

The system 100 of FIG. 1 further includes at least one client device 160 in communication with the in communication with the server device 102 via a suitable network, e.g., the network 101, as discussed below. The exemplary client device 160 may be configured to interact with the server device 102, as are illustrated therein. The client device 160 includes a processor 162 in communication with memory 164 that is configured to execute instructions and applications stored therein. In accordance with the example embodiment, the memory 164 stores a thin client 152 that is configured to present a client user interface 150 to an associated user. In some embodiments, the thin client 152 may be implemented as a suitable web browser capable of accessing and presenting the client user interface 152, thereby presenting information and data received from the server 102, etc.

The client device 160 may include one or more input/output (I/O) interface devices 168 and 170 for communicating with external devices. The I/O interface 170 may communicate, via communications link 186, with one or more of a display device 172, for displaying information, and a user input device 174, such as a keyboard or touch or writable screen, for inputting text, and/or a cursor control device, such as mouse, trackball, or the like, for communicating user input information and command selections to the processor 162.

It will be appreciated that the system 100 is capable of implementation using a distributed computing environment, such as a computer network or cloud-based computing platform, which is representative of any distributed communications system capable of enabling the exchange of data between two or more electronic devices. It will be further appreciated that such a computer network includes, for example and without limitation, a virtual local area network, a wide area network, a personal area network, a local area network, the Internet, an intranet, or the any suitable combination thereof. Accordingly, such a computer network comprises physical layers and transport layers, as illustrated by various conventional data transport mechanisms, such as, for example and without limitation, Token-Ring, Ethernet, or other wireless or wire-based data communication mechanisms. Furthermore, while depicted in FIG. 1 as a networked set of components, the system and method are capable of implementation on a stand-alone device adapted to perform the methods described herein.

The client device 160 may include a computer server, workstation, personal computer, cellular telephone, tablet computer, pager, combination thereof, or other computing device capable of executing instructions for performing the exemplary method.

According to one example embodiment, the client device 160 includes hardware, software, and/or any suitable combination thereof, configured to interact with an associated user, a networked device, networked storage, remote devices, or the like.

The memory 164 may represent any type of non-transitory computer readable medium such as random access memory (RAM), read only memory (ROM), magnetic disk or tape, optical disk, flash memory, or holographic memory. In one embodiment, the memory 164 comprises a combination of random access memory and read only memory. In some embodiments, the processor 162 and memory 164 may be combined in a single chip. The network interface(s) 168, 170 allow the computer to communicate with other devices via a suitable communications link 186 to a computer network 101, and may comprise a modulator/demodulator (MODEM). Memory 164 may store data the processed in the method as well as the instructions for performing the exemplary method.

The processor 162 can be variously embodied, such as by a single core processor, a dual core processor (or more generally by a multiple core processor), a digital processor and cooperating math coprocessor, a digital controller, or the like. The processor 162, in addition to controlling the operation of the client device 160, executes instructions and applications stored in memory 164 for performing the method described herein.

In addition to the foregoing, the system 100 includes one or more meter devices 200, in communication with the server device 102 via a communication link 188.

That is, the meter devices 200 may utilize a communications link 188 with the server device 102, which allows transmission of status information 128 to the server device 102. Suitable status information 128 may include, for example and without limitation, power supply status (e.g., battery life remaining, power available, etc.), connectivity status (e.g., network connectivity, home/apartment/building connectivity, etc.), flow rate, usage data, etc. In one embodiment, the meter device 200 may be implemented as a cellular, web-enabled, proprietary network enabled metering device utilizing a common or proprietary operating system. Accordingly, the meter device 200 is representative of any suitable computing devices, proprietary network devices, or other web-enabled electronic devices. The data communications link 188 between the meter device 200 and the server device 102 may be accomplished via any suitable channel of data communications such as wireless communications, such as, for example, a cellular communications network. In other embodiments, the data communications link 188 may be implemented using other networks, including, for example and without limitation, Bluetooth, WiMax, 802.11a, 802.11b, 802.11g, 802.11(x), a proprietary communications network, infrared, optical, the public switched telephone network, or any suitable wireless data transmission system, or wired communications. In one embodiment, the meter device 200 may communicate with the server 102 via the network 101.

FIG. 2 provides an example illustration of an exemplary meter device 200 representative of the meter devices depicted in FIG. 1. The meter device 200 may include a processor 202, which executes one or more instructions or applications 214 in the performance of an exemplary method discussed herein. The meter device 200 may further include a memory 204 storing a monitoring application 214 in data communication with the processor 202 via a system bus 206. In some embodiments, the memory 204 may further store usage data, as will be appreciated. In such embodiments, the memory 204 may retain a preselected amount of usage data corresponding to a predetermined time period, e.g., a 15-day period, a 30-day period, a 45-day period, a 60-day period, or the like. The processor 202 of the meter device 200 may be in data communication with the server device 102 via an I/O interface 210. The meter device 200 may further include a power supply 208 suitably configured to provide power to the various components of the meter device 200. Suitable examples of such power supply 208 may include, for example and without limitation, wired power, inductive power, battery(ies), solar power, or the like. In some embodiments, the power supply 208 may include, for example and without limitation, suitable power handling and conversion components, e.g., capacitors, transformers, resistors, inverters, etc.

As shown in FIG. 2, the meter device 200 may include an inlet 216, an outlet 218, flow meter(s) 220, and the like. In other embodiments, the meter device 200 may be configured with multiple inlets, outlets, and the like. It will be appreciated that other fluidic handling components, e.g., valves, cutoffs, regulators, etc., although not shown, may also be operatively coupled and controlled or in communication with the meter device 200. It will further be appreciated that while illustrated as a separate component, the flow meter(s) 220 may be resident in memory 204, externally coupled to the meter device 200, or a suitable combination thereof.

The memory 204 may represent any type of non-transitory computer readable medium such as random access memory (RAM), read only memory (ROM), magnetic disk or tape, optical disk, flash memory, or holographic memory. In one embodiment, the memory 204 comprises a combination of random access memory and read only memory. In some embodiments, the processor 202 and memory 204 may be combined in a single chip. The network interface 210 allow the meter device 200 to communicate with other devices via a communications network, and may comprise a modulator/demodulator (MODEM). Memory 204 may store data the processed in the method as well as the instructions for performing the exemplary method. The digital processor 202 can be variously embodied, such as by a single core processor, a dual core processor (or more generally by a multiple core processor), a digital processor and cooperating math coprocessor, a digital controller, or the like.

The memory 204 of the meter device 200 includes a monitoring application 214. The monitoring application 214 of the meter device 200 may be configured to include a flow analyzer component 222, a timer 224, a communications component 226, and the like. In accordance with some embodiments, the flow analyzer component 222 may facilitate in detecting leaks, as well as backflow and communicating the same to the server 102 via the communications component 226. In some embodiments, the communications component 226 in conjunction with the network interface 210, may enable the meter device 200 to communicate with the server device 102 via the network 101, as discussed above.

As shown in FIG. 1, the meter devices 200 are capable of intermittent (opportunistic) or continuous bi-directional communication with the server 102 utilizing the I/O interface 210. In some embodiments, the meter devices 200 may be configured for one-way communication with the server 102 utilizing the I/O interface 210. In such embodiments, the communication is data communication utilizing a cellular data network, e.g., 3rd generation mobile phone standards (3G), 4th generation standards (4G, 4G LTE, WiMax), 5th generation standards (5G, etc.), EV-DO, standalone data protocols, and the like. In such an embodiment, the meter devices 200 communicate with the server 102 using the network 101.

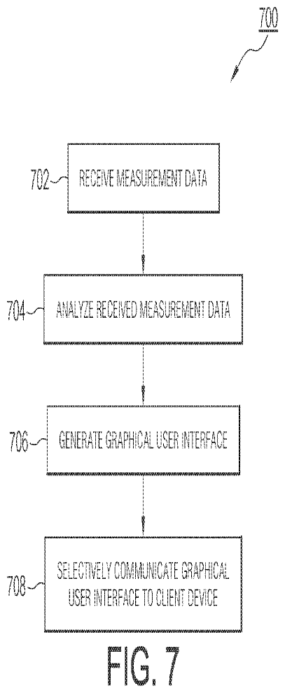

Turning now to FIG. 7, there is shown a flowchart illustrating a method 700 for water usage monitoring and meter health in accordance with one embodiment. As shown in FIG. 7, the method 700 begins at step 702, whereupon measurement data corresponding to water usage is received from a meter 200 over a communications network 101. As will be appreciated, the meter 200 may communicate with the server 102 of the system 100 via a cellular communications network. At step 704, the received measurement data is analyzed to determine at least one property associated with the water usage. Suitable examples of such properties include, for example and without limitation, total water consumed, flow rates, inlet rates, outlet rates, and the like.

At step 706, a graphical user interface is generated by the server 102 depicting the at least one property associated with water usage based upon the analysis performed at step 704. In some embodiments, the graphical user interface may be a thin client or web-based interface, e.g., a portal 120, capable of displaying a plurality of different screens, images, graphs, charts, forms, reports, etc., associated with client devices, meters, usage, etc. At step 708, the graphical user interface is selectively communicated to the client device. It will be appreciated that such communication may include, for example and without limitation, pop-up alerts, emails, text messages, thin-client (e.g., web-based) communications, and the like. Additional information on the method is described in the various aspects and examples below.

In one aspect, the measurement data may include a measurement of water flow.

In one aspect, the method 700 may further include the steps of receiving historical water usage data from an external source and comparing the received historical water usage data with the received measurement data.

In one aspect, the method described above may include determining that a leak is present based on a result of the comparing of the received historical water usage data with the received measurement data, generating an electronic communication alert in response to the determination that a leak is present, and sending the generated electronic communication alert to the client device.

In one aspect, the method may further include determining a backflow is present in accordance with a result of the comparing of the received historical water usage data with the received measurement data, generating an electronic communication alert in response to the determination that a backflow is present, and sending the generated electronic communication alert to the client.

In one aspect, the measurement data includes health data corresponding to the associated meter.

In one aspect, health data includes a battery level of the associated meter. In such an aspect, the method further includes generating an alert when the battery level of the associated meter is below a predetermined level, and communicating the generated alert to the client device.

In one aspect, the health data includes a signal strength. In such an aspect, the method further includes generating an alert responsive to a signal strength below a predetermined level, and communicating the generated alert to the client device.

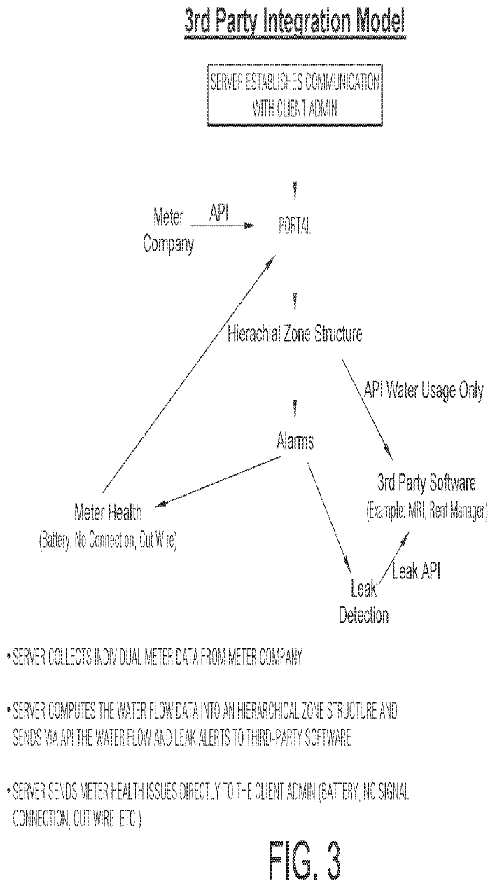

The foregoing description of components illustrated in FIGS. 1-2 and the interactions thereof, may be better understood in conjunction with the illustration of FIG. 3, and the flowchart of FIG. 7 in combination with the example implementation and aspects discussed hereinafter. It is to be appreciated that the terms “Kaptech Submetering” “Kaptech Water Submetering” or “Kaptech” are used interchangeably herein for the system 100 described above.

### Example Implementation

In the example embodiment, the Kaptech Water Submetering system 100 solves issues in regards to keeping track and organize multiple submeters in the commercial, industrial, rental and homeowner association industry. The system 100 provides an online portal hardware/software system 120 that is accessible by clients, owners, tenants, etc., to accurately identify water flow, conservation measures, meter health and when employed, offer in the same portal, a utility billing system. The system 100 combines all these analytics to alert the property owner of leak detection, backflow, cellular connection and battery health through alarms and notifications. When an API is established between a third-party entities, e.g., billing entities (software/hardware, etc.), the system 100 is configured to transmit needed data, as well as to continue alerts and notifications. In embodiments wherein a third-party entity is not used, the system 100 is configured to automatically generate and communicate reports on the aforementioned information.

When employed in the property management business as a tenant management billing system, the portal 120 processes payments for tenants water use, mitigates water leakage damage and provides many other related features. Most importantly, when people visually keep track and pay for their water use, they will understand how much water is wasted and figure out how to conserve. It will be appreciated that when tenants are responsible for payment of their actual water use, overall water usage declines by up to 41%.

### Data Flow:

From a mechanical standpoint, the ultrasonic submeter (i.e., the meter 200) takes a “snapshot” of water utilization every 15 minutes. Each meter is connected to a “cellular endpoint;” a wired transmitter on the cellular frequency band, electrically powered by a 12 to 20 year battery. From a UI standpoint, this transmitter takes water data accumulated within the meter and sends it to the water meter manufacturer's portal. An application programming interface (API) then captures the data, which is then translated into the portal 120.

### Portal 120:

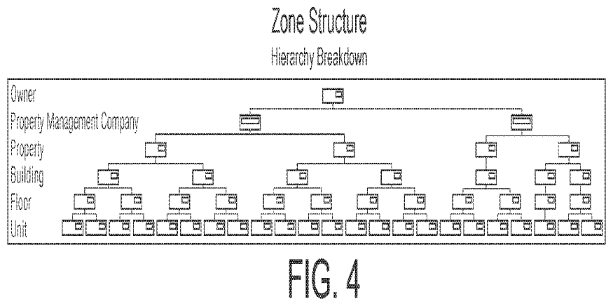

The system 100, in accordance with this example embodiment, utilizes a “Hierarchical Zone Structure” system architecture, as illustrated in FIG. 4. As will be appreciated, such an implementation enables organizational flexibility regarding how the data of each meter is organized. The organizational aim is primarily for submetering water usage into Zones or layers. Separate units in a property, building or facility, can be multiplied many times over into “Hierarchical” layers. Each layer begins from one, to an unlimited number of submeters 200, organized into the next single layer or one unit. Multiple meters data can be combined into one unit. All these layers are organized into the portal 120 for the Super Administration, Client Administration and with permissions, Manager, and, in some embodiments, the Tenant when combined in a billing system. Additional features and components of the portal 120 are described below in the various aspects of the subject application.

### Example of the “Hierarchical Zone Structure”

Single property with multiple tenants. Multiple tenant's water usage is submetered and monitored into one property unit. One property unit can be multiplied into an unlimited number of property units. Properties can be organized in many layers, such as multiple floors per building, multiple buildings on a single site, multiple buildings per state. Custom layers can be organized how the owner sees fit.

Keeping track of how a corporation uses its water and conservation efforts. Corporations have facilities in multiple locations around the world. Each facility may have different usages and locations of water distribution. A facility can be monitored by and within any number of Zones, within a building, within a campus, and across the corporation's locations.

Inside a building there could be two separate water lines, e.g., hot and/or cold lines, or multiple water distribution points that enter one location. The system 100 is capable of aggregating aggregate multiple meters as if they are one unit, or at the same time separate out the meters for both types of monitoring. Each unit is monitored in a custom Zone or layer of meters. As noted above, FIG. 4 provides a graphical illustration of the hierarchical zone structure referenced herein.

### Billing System:

The portal 120 may be configured to provide a water billing system correlated to each submetered data collected. Each meter may be organized into a Dynamic billing period. During the billing period, water and sewer use may be calculated and multiplied by the cost of the water utility rate. The sewer rate may be is normally calculated the same way as water. Optional line charges can be added to a final billing cycle for any reason beyond water and sewer, such as trash collection, parking or even the monthly rent. These line charges can be set for a single, multiple or ongoing cycle.

### Integration Setup:

The aforementioned API connection can be established for seamless integration to a client's third-party CRM or billing software for water flow data and calculated costs for water and sewer. Depending on the capabilities of the 3rd party entities, Leak Alerts can also be sent via API. Meter health alerts such as Missed Meter Check-Ins, Battery Life and Cut Wire are sent directly to the Client Admin via Email.

### Onboarding Portal and Payment System:

In accordance with this example embodiment, the system 100 works with the Client Admin to organize the Zone structure and rules. A second log-in is required for the submeter Tenant to open an account and add their personal information. This Tenant information is how they will pay for their usage through a credit card or ACH and how they receive alerts and updates, or an election to have enabled such alerts and/or updates. The billing payment details do not save on the server 102 but transfer to an external payment service. Both the owner and tenant can log in anytime on each side of the system for updating data and viewing usage. In some embodiments, a Tenant may not alter payment information without Client Admin approval. When a payment is not made for any reason, the owner will be visually alerted on the portal or in reports so they can make appropriate adjustments. Payments are directed to the Client Admin's bank, not through system 100. If a meter 200 is on a vacant unit, the alarms can be directed to the owner in case of leaks or squatters.

The Client Admin may be able to view their entire Hierarchical system, and through the portal 120, each tenant's usage and bill. The Client Admin can also view water usage system wide, property, building, floor, or unit view.

### Leak Detection:

Through flow analysis over a 24 hour period and several days, the meter manufacturer API, will alert the system 100 of uninterrupted water flow. The server 102 or other device of the system 100 may interpret the data as a possible leak. Via the portal 120, the system 100 may send an alert of the leak detection to the Client Admin and/or the Tenant, an email and/or text if a leak is detected. Quick leak detection saves property damage and is important for water conservation. Additional submeters can be placed throughout a facility where leak detection is important for water flow monitoring purposes.

### Backflow Detection:

Through flow analysis over a 24 hour period and several days, the meter manufacturer API, will alert the system 100 of uninterrupted water flow or change in flow direction. The server 102 or other device of the system 100 may interpret the data as a possible backflow. Via the portal 120, the system 100 may send an alert of the backflow detection to the Client Admin and/or the Tenant, an email and/or text if a backflow is detected. Quick backflow detection saves property damage and is important for water conservation. Additional submeters can be placed throughout a facility where backflow detection is important for water flow monitoring purposes.

### Multiple Meter Under One Tenant or Unit:

The portal 120 can be programmed to allow multiple meters to be placed under one tenant. An example is when a subunit has a hot water and cold water separate water lines going into one tenant property. The combination of multiple lines are combined into a single flow reading.

### Reporting

All the data gathered by the system 100, through the portal 120 can be aggregated into one or more types of printable reports. For example and without limitation, one such printable report may be a usage report for each meter and group of meters over time periods of year, month, day hour and 15 minute intervals. A second such printable report may be an account payable and receivable reports showing each meter and groups of meters.

The system 100 may include one or more options relating to billing, e.g., depending upon the contract with the Client Admin, the Tenant, etc. While the system 100 may allow for a single price across the board, variables that may indicate different amounts include, for example and without limitation, primary meter with tenant, secondary meter with tenant, primary meter without tenant, secondary meter without tenant, and the like.

### Convenience

The system 100, as will be appreciated by the skilled artisan, provides several features of convenience to Client Admins, Tenants, and the like. For example, usage of the system 100 does not require electric hook-ups, i.e., no electrical connections. The meters 200 may be implemented with a 12 to 20 year minimum life expectancy. Variations on the life expectancy may be based on the type of communication signal used, the strength of the signal, surrounding temperature, etc. In embodiments wherein the meter 200 utilizes a cellular communication network, Wi-Fi (i.e., wireless Internet connection) is not required, and thus retrieving/receiving usage data or other metrics need not depend on a functioning Wi-Fi network. Updating of Tenant information mid-month provided, with ease of separation of billing between previous and current Tenants. Tenants receive invoices electronically via the portal 120, so no sub-meter company personal are needed avoiding mistakes and/or delays. Meter health is reported directly to the portal 120, minimizing staffing requirements and billing delays.

### Encourage Conservation

The system 100 described in this example implementation provides for the reduction in water usage by 15-41%. It will be appreciated that if someone pays a blanket amount for their utilities, since they “already are paying for the utilities” they would use as much as they want and more. When the Tenants have to pay for their own water, there is a tendency towards conservation. For example, when brushing teeth, using the water to wet the toothbrush before use and then using the water again at the end of brushing to clean the brush uses 1/100th of the water in comparison to leaving the water running. So the added conscientiousness reduces the overall water use footprint.

### Quality

In the example implementation described herein, the meter(s) 200 are Tier 1 utility approved, with quality for very long life. City Utility companies use the same physical product for homes. No more human error involved in recording meter data, because the water flow data goes right into the portal 120 every 15 minutes. In some instances, the meter 200 is capable of storing the water metrics for 45 days. For example, if there is a new ice machine blocking the reception, the data is saved and a message is sent to the Client Admin informing that something is blocking the reception. Furthermore, use of the system 100 described herein enables printable, downloadable, API-friendly, integratable communications with the Client Admin accounting components, e.g., hardware/software, third-party service provider, etc.

In accordance with a first aspect, the system 100 includes a hierarchical zone structure that allows for the grouping and flow of data/processing systems to be done in an extremely organized manner. An example of a Hierarchical Zone Structure is below: Property Owner→Property Management Company-->Property-->Building-->Floor-->Apartment Unit. In such a first aspect, the initial level references a “Zone”. Zones further down on the chain are called Child Zones. Several Zones along the same level in the chain are called Sibling Zones. Zones higher up on the chain are called Parent Zones. Example of Hierarchical Zone naming: In an apartment building, each floor is a “Child Zone” of Building. Each floor is also a “Parent Zone” of all the apartment unit “Children Zones”.

In this aspect, when a Client Admin owned one building that has a single floor, they would only need two Zones levels. The building and Unit. This would cause that account's Hierarchical Zone Structure to only have two Zone levels. Managers can only see data from the Zone that they are assigned to and it's Children Zones. Tenants can only see data from their Zone. Payment for bills can be directed towards multiple recipients, divided up and organized based on the zone hierarchy. Bill data is gathered from the most Child Zone to the most Parent Zone. This way, Tenants can receive a bill line item pertaining to only the Parent Zone they reside in and other tenants would not see that billing line item. When the bill is being generated, the portal gathers billing related data from the “Edit Zone” and “Manage Fees” pages data; starting from the most Child Zone and ends at the most parent zone. Example: The Client Admin makes one specific Tenant have a greater late fee as a penalty for many late payments. The Client Admin can specifically add the late fee in the “Edit Zone” page for that unit 10 dollars. (While everyone else in the building has a 5 dollar late fee.) Each separate Zone's bill payment(s) can be directed to a different recipient. Example. Multiple people own a building. Each person can receive payment from specific Tenants. Assigning water rate information automatically applies to the Zone and it's Children Zones; thus affecting all Tenants belonging to those Zones.

In accordance with a second aspect, the system 100 may include four (4) roles (user access levels) accessible through the portal, i.e., the client interface. 1) Super Admin, e.g., administrative staff associated with the system 100, 2) Client Admin, e.g., the landlord or property owner, 3) Manager Admin, e.g., staff having lesser access than Client Admin such as on-site management, maintenance personnel, etc., and 4) Tenants, e.g., occupants or users of the water that is being metered. In such an aspect, the users having Super Admin access may be provided with access to all features of the system 100. Client Admin have complete access to all features in the portal except: 1) alteration of service fees, 2) access to the Super Admin panel, 3) access to other client accounts, and/or 4) alteration of zone structure and meter information. Users having Manager Admin rights have complete access to all features in the portal only when assigned by the Client Admin. Tenants can only see their water flow data, their account information and change their method of payment. Tenants cannot remove payments.

In accordance with a third aspect, Account Impersonation is provided to users have Super Admin rights. The ability for Super Admin to switch from account to account without a login procedure. When impersonating an account, Super Admin is able to see all the details specifically pertaining to that account. They act as Client admin for that account but have even more permissions and roles.

In accordance with a fourth aspect, the client interface may include a search bar where information is searchable via: Tenant First Name, Tenant Last Name, Building Name, Company name, Property name, Tenant phone number, Tenant email address, Meter Number, Invoice number. In such an aspect, Super Admin/Client Admin/and Manager roles may be able to search for any Zone, Tenant or Billing related information. See above search types. This search bar resides in the top right corner of the “Tenants and Utilities” Tab/View. The search bar access is limited to each user's role and view within the Hierarchical Zone Structure.

In accordance with a fifth aspect, opening the portal 100 takes the Client Admin to a Dashboard, e.g., a graphical user interface representation of usage information, user account information, and the like. In such an aspect, the Dashboard shows the water usage of the current month view of the entire portfolio of properties.

In accordance with a sixth aspect, the system 100 may include the capability of integration with third-party billing, utility or a client's own/proprietary CRM software. After analyzing the endpoints of the external software, the water usage data, dollar amount calculation and various alerts such as water leakage detection, backflow detection, low battery detection and low cellular reception are provided via API from the portal to a third-party billing software (e.g., Rent Manager and MRI) if requested by the Client. In one example implementation, the aforementioned API may be configured (e.g., setup) with an external client's billing software, e.g., a CRM. In such an implementation, a Client Admin may, through the portal, enable the API to set up CRM to enable external payment options.

In accordance with a seventh aspect, the system 100 may include the ability to take water usage data several times a day from a third-party monitoring service, e.g., AquaCue Portal by Badger Meter®. Water usage data is extracted from Badger Meter by polling the API on a schedule. The amount of times the API request occurs may be increased or decreased. The portal 120 may include one or more internal checks to ensure that the database holding the water usage data is present. If data is missing, the server 102 may be suitably configured to backfill the data at the next assigned API polling. Once the API of meter flow data enters the Super Admin database (e.g., data store 144), it gets associated with the appropriate Zone and appears in the User Interface (i.e., on the portal 120) in reports, water meter flow table and the water utilities billing list.

In accordance with an eighth aspect, the system 100 multiple meters 200 associated to one unit. Allows for the ability for more than one meter 200 to be linked to a Zone. For example, in a single apartment unit, one meter can be connected to a cold water pipe and one meter 200 connected to a hot water pipe. The water flow of multiple meters linked to one Zone is added together for reporting and is reflected in the tenant's bill.

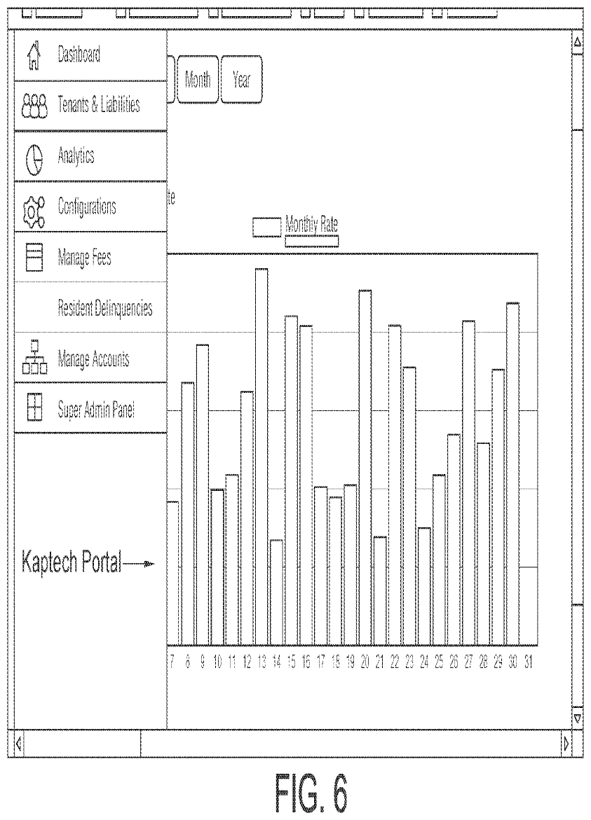

In accordance with a ninth aspect, the system 100 provides for water flow reports. In such aspects, the water flow report may illustrate use over time in bar graph form. The time breakdown in the report may appear in any suitable increments, e.g., 15 minutes, hourly, daily, weekly, monthly, and yearly timeframes. FIG. 6 provides an illustrative example of such a graph in accordance with some embodiments. When mousing-over any bar in the graph a hover button would appear showing the associated dollar value and gallon usage. Tenants are only able to see the report associated with the Zone they were placed in. Clicking a bar on the bar graph drills down into that bar's more detailed view. For example, clicking on a month “July” changes the bar graph to show the water readings of all the days within July.

In accordance with a tenth aspect, the system 100 may enable Client Admin scheduled summary emailed reports. There is a feature that allows the Client Admin to create a monthly emailed 5 column Summary Report of all—dates, water usage, funds received, funds owed and alerts—all within the given billing period. The Client Admin chooses, at which points of the Hierarchal Zone Structure they wish to see aggregate reports of all the above mentioned information. Each Zone that has the same email address results in a new tab appearing in the Summary Report. The first tab of the (Excel) report has the grand total of all the tabs' information. Example: the Client Admin can decide to see an aggregate of all their buildings combined but also wishes to see the aggregate data of a specific unit. Their monthly report would have two tabs. One showing the aggregate of all their buildings and the 2nd tab would show the aggregate data for only one unit. Additionally, multiple email addresses can be entered (separated by commas) into each zone level allowing more than one email to receive the same report. There is a validation process when entering an email address to receive the Scheduled Summary Emailed Report. An email address is only accepted if that address matches with one found on the staff Configurations page. Each Scheduled Email Report that is chosen to be received by the Client Admin, is generated and sent after system processes, one hour to three days after the billing period. Client Admin decides the time frame to process. Data shown in the Scheduled Summary Emailed Report (SSER) will be from Dynamic Billing Period to Dynamic Billing Period. For example, the summary report view may include a summary of each column at the top. The Alert Column would have the alert name and the number of that alert type within that Zone or Descendants. It will be appreciated that the tenth aspect may be facilitated on the portal 120.

In accordance with an eleventh aspect, the system 100 enable Client Admin users to selectively download reports. This feature allows Client Admin to download a report based on their own search filters. There is a “Report” icon on each Zone Level. Clicking on the Report icon will open up the Report page specifically for that zone and its descendants. Clicking on any line of the report will bring the user to the Zone belonging to that line; showing all relevant information relating to that Zone. Download Report section is located at the top of the Reports page. The Download Report section includes: Title of report—“Download Report”, Calendar Date Selector, “Broken Down By” Selector. Selects how the report rows should be broken down. Options are Daily, Weekly, Monthly, Yearly. Only one option can be selected at a time. Whichever one is selected has a different color than the rest. Example: Choosing “month” of a report shows the data broken down into the months of the year. Choose Report Type Selector, may include a dropdown that allows the Client Admin to choose between downloading a PDF of the Summary Report or one of the other report types (Water flow, Unexpected Use, Missed Meter Check Ins, Financial).

In accordance with a twelfth aspect, the system 100 may include an ability to report for missed meter check-ins. This report may be accessible from the report page, or also be accessed by clicking on the missed meter check in badge located in the manage water meters list. Report components may include, for example and without limitation, Title—Missed Meter Check-ins, Meter ID, Tenant Name, Zone, Check-In Dates Missed, Check-ins missed, Current Status. In some embodiments, the logic of reporting order may include: if a meter has not checked-in multiple times concurrently, there would only be one row; if there is then a positive check-in and then more missed check-ins, a second row would get created showing a new check-in missed date. The portal may further provide column header functions: Clicking on “Check-In Dates Missed”—Puts the searched list in chronological or backwards chronological order. Clicking on Tenant Name to put the Tenants in chronological order or backwards chronological order. Clicking on the Zone puts the list in alphabetical order. Clicking on Check-ins missed, sorts the list by meters with most check-ins missed to least amount of check-ins missed. Clicking on Current Status sorts the groups the meters by status. Example search terms: entering in a Zone such as “Building 1” brings up any results of that Zone and corresponding Children Zones.

In accordance with a thirteenth aspect, Super Admin and Client Admin have a checkbox in their edit sections to enable and disable notifications. It is the Client Admin Role that decides which Managers should have notifications on or off.

In accordance with a fourteenth aspect, for Super Admin, Client Admin and Tenants, on a notification page of the portal 120, a search bar just for notifications is provided. All the notifications appear searchable by: name of notification, Zone, and date range calendar picker. Under the search bar is a list showing all notifications that have been sent out in the above selected period of time. Default is past 24 hours of notifications. Users can only see notifications of the Zones they are placed in and their Child Zones.

In accordance with a fifteenth aspect, the system 100 provides leak detection capabilities. When a leak is detected, an API (Application Programming Interface) is sent from the portal. Once the signal reaches the portal, it associates the Leak Alert Signal with the appropriate unit. There are notifications showing the Client Admin and Tenants portal users that there is a leak shown via: Email and Notification Page. The Client Admin would see an additional leak Badge appear next to that Zone's Meter information in the Manage Water Meters page. Automated reporting of the leak detection to the tenant, the building manager, client, etc.

In accordance with a sixteenth aspect, the system 100 may automatically report unexpected water usage. For example, if an inactive (vacant tenant unit) water meter 200 becomes active, after e.g., 50 gallons of use, the system 100 may interpret such usages as: 1) a new tenant has moved in and started using water before they were entered into the portal; 2) there is a squatter at the unit; or 3) there is a water leak to correct. Such unexpected water usage is then communicated to the Client Admin automatically. For example, an email may be sent to the Client Admins who have tenants to remind them to add the tenant into the system, or check for squatters. In some embodiments of this aspect, the trigger for this notification is when there is water usage on a meter but not associated with a Tenant. Client Admin must have removed the Tenant in the “Manage Tenants” section of the portal 120 for this to occur.

In accordance with a seventeenth aspect, the system 100 may provide an email communication to a Client Admin in response to a payment method being unapproved. For example, even when an automatic payment option has been enabled for bill payments, if the payment account is closed, or funds fail to transfer, the system 100 may be configured to flag that account and prior to sending the next invoice, an email reminding of payment due is communicated to the Client Admin.

In accordance with an eighteenth aspect, the system 100 may provide a notification to a delinquent Client Admin. For example, if the Client Admin's invoice becomes delinquent, a notification to the portal 120 and/or the Super Admin may occur.

In accordance with a nineteenth aspect, the system 100 may provide a notification to a delinquent Tenant that payment is past due. For example, the portal 120 may send an email notification to the Tenant notifying the Tenant of a past due amount, late charges, water cut-off, and the like.

In accordance with a twentieth aspect, the system 100 may provide a payment notification communication to the Client Admin. For example, after payment has been received from the Client Admin, the Super Admin or portal 120 may electronically communicate a receipt, thank you email, etc. regarding the received payment.

In accordance with a twenty-first aspect, the system 100 may add an overdue payment badge, e.g., a notification icon, to a Tenant list appearing to the Client Admin via the portal 120.

In accordance with a twenty-second aspect, the system 100 may provide a shared documents page on the portal 120. In such an aspect, a Client Admin may upload and share documents via email through the portal 120 to Tenants in the Hierarchical Zone Structure. For example, sending an email to the Zone designated as Floor 2 would send an email to all Tenants located on Floor 2. The shared documents page of the portal 120 may further include a “compose message” icon, which when selected, may enable a modal window to appear displaying 1) Zone—There would be a Zone Selector to indicate where the message goes to. 2) Start and end of the event. 3) Date/Time of mail sending 4) Subject line of event and 5) File attachment button. Thereafter, the message may then be emailed to the Tenants that have emails belonging to that Zone and its Children Zones. In some embodiments, a trash or garbage icon may be presented, with the selection thereof resulting in the deletion of the message.

In accordance with a twenty-third aspect, the system 100, via the portal 120, provides a field in each “Edit Zone” page to input the email address that would appear in Tenant communications belonging to those Zones. Accordingly, any such outgoing messages would have the email saying “noreply@abccompany”.

In accordance with a twenty-fourth aspect, the system 100 may include an ability to distinguish between non-Tenant meters and Tenant meters. A distinction may be made between meters that are supposed to report on tenant activity and meters that are supposed to report on other metered water, such as laundry machines and landscaping. This feature may include result in canceling the email that goes out in this scenario of water usage in non-tenant zones. Methods of making the distinction include, for example and without limitation, in the CSV upload, there is a column indicating if this meter is for tenants or non-tenants; in the Zone Edit section of the portal, there is an indicator if this is a tenant zone or not, and the like. In some embodiments of this aspect, such a distinction may be limited to the Super Admin.

In accordance with a twenty-fifth aspect, the system 100 may include settings of the portal 120 enabling “pop-up” alerts. In such an aspect, a downloadable program that causes the alerts for that user to appear on the bottom corner of the operating system. In some embodiments, the alert stays open until clicked upon, there is a button that makes the alert disappear, and/or clicking on or selecting the alert takes the recipient to the Notifications and Alerts area of the portal 120.

In accordance with a twenty-sixth aspect, the system 100 via the portal 120 may provide a notification and alert badge for a missed meter reading to the Client Admin. In such an aspect, such an alert may be generated approximately 72 hrs after no communication from that meter sends is received. Notifications to the Super Admin and the Client Admin to fix a possible cell reception blocking situation may then be communicated. In some embodiments, the data received into the portal 120 may be organized/analyzed by the system 100 to determine a lack of flow by reviewing missed readings. Meters that have new flow data after an API call from portal 120 or third-party processor are then matched. In the event that missing entries are identified, the corresponding meters are flagged as “missed communication”. If the status continues for a predetermined period of time, e.g., 72 hours, alerts may be communicated via the portal 120 to facilitate resolution of the problem. In the event that a successful meter reading occurred within that predetermined period of time, the flag may be cleared. In some embodiments, a “Missed Read” table per Client Admin is generated to log the missed meter check-ins. According to some embodiments, a “Missed Communication” record is generated of each meter's missed communication” is kept for future reporting purposes. For example, the record may include each meter's no check-in list of dates and times, total number of missed check-ins this calendar year per meter, total number of missed check-ins since installation per meter, or the like. Missed Communication notifications may be communicated to the Client Admin directly (e.g., email with Zone chain, meter ID, missed check-in dates, hyperlink to portal 120, etc.), dashboard of Client Admin (listing of all applicable meters), dashboard of Super Admin, etc.

In accordance with a twenty-seventh aspect, the system 100 may implement a variety of security protocols. For example, a set-up for user authentication for log in may be implemented for the various roles regarding the portal 120. Such set-up may include setting login credentials (username/password), a “forgot username/password” links for assistance in determining their login credentials and/or resetting their login credentials. Another security protocol implemented by the system 100 may include an automatic log-out, wherein if any client-side user is logged in, that user is logged-out of the portal 120 after a predetermined period of time, e.g., 10 minutes, 15 minutes, 20 minutes, etc. A guest mode security protocol may also be provided in such an aspect, wherein a user may log on as guest (e.g., bill payment from a public computer), whereupon if guest mode is selected, log out will automatically occur within the predetermined period of time and not persist the authentication cookie.

In accordance with a twenty-eighth aspect, the system 100 may provide a variety of uploading and downloading capabilities. In such an aspect, the system 100 may provide on-boarding meter CSV input, wherein the portal 120 includes a CSV uploader function on the Super Admin panel which allows Super Admins to create a zone structure by accepting the information of the meter and assigning it to a specific zone within the zone structure. When entering “N/A” in a Zone column of the Meter Installation CSV, it causes the portal system to ignore that Zone Level of the Hierarchical Zone Structure. The Tenant upload may be able to happen earlier in the Client Admin Onboarding Process then the installation CSV. The Tenant CSV can make and add to a zone structure and the installation CSV upload would create any Zones not covered in the existing zone structure. In such an aspect, the portal 120 may provide a CSV file uploader for Tenants. For on-boarding purposes, the Client Admin is able to upload a list of Tenants information to associate it with a water meter unit. In such instances, a CSV upload creates a Dynamic Hierarchical Zone Structure, wherein a unique identifier may be added by the Client Admin. Such an instance may implement validation requirements, e.g., no new Zones can be created through the Tenant CSV Uploader, new Tenant information can be submitted if that row in the CSV file shows the same Zone name as what already exists in the portal from the Meter CSV upload. Furthermore, building floor and suite number may all have to be validated against existing zones, and validation failures may be scanned to prevent the import before the data begins transferring. In such aspects, a CSV upload error log may be generated. Such an upload error log may provide the Super Admin and/or Client Admin with a notification as to what information was incorrectly uploaded. When any information is submitted with errors, the user is sent a CSV Error report, showing which rows caused the file to be unable to get uploaded and the reason for the error. The CSVs this may be applied to include, for example and without limitation, Meter Installation CSV (Meters info intake and assigning to Zones), Tenant Information Upload CSV, and the like. Additional features of this aspect include, for example and without limitation, downloading and printing of Tenant data, database backups, and the like. The ability for a Client Admin to download and print specific tenant information, may include a zone selector (e.g., the Client Admin wants to print out one building's list at a time), an option of selecting which columns should be included in the tenant CSV downloads. When clicking on the download tenants button there are several options to customize the Tenant Information List.

In accordance with a twenty-ninth aspect, the system 100 may provide a number of billing services and features. For example, the system 100 may include an option to inform the Super Admin that the Client Admin has begun to incur meter charges. For example, installation of meters for all units in a building takes a certain amount of time. During this time, some analytics may be acquired, but after installation of a predetermined number of units, or all units, charging to Tenants may begin.

In accordance with a thirtieth aspect, the system 100 may provide a billing service enabling the addition or removal of Tenants as related to the water bill between the Super Admin and the Client Admin. This will allow the web service rate to change from meter with Tenant pricing to meter with no Tenant Pricing. The possibly new price then gets charged to the Client Admin. For example, instead of with tenant price (5.00 USD) for the billing fee for that unit we would charge them the non-tenant price (2.50 USD), or the opposite for adding a tenant later then the billing statement date.

In accordance with a thirty-first aspect, the system 100 may provide water and/or sewage tier by system. During the billing process to the Tenants, the server 102, via the portal 120, calculates the rate of water used, using the water and sewage bill (from the utility company) information. The inputs to the portal 120 for the tiered water billing methods of the utility companies allows for flexibility towards multiple billing structure types. In some aspects, the system 100 may utilize equations/formulae account for tiered billing structures plus fixed amounts.

In accordance with a thirty-second aspect, the system 100 may provide a payment system between Tenants and the Client Admin. That is, a Tenant may log into the portal 120 and pay their utilities. A payment gateway may be established between the Tenant and the Client Admin.

In accordance with a thirty-third aspect, the system 100 may be configured to add a payment method for Tenants. In such an aspect, the payment method may be viewable to the Super Admin and/or the Client Admin via: 1) the Current Card with the last 4 digits of the card should be seen in each individual bill. If a check was used to pay the bill it says Paid via “Check . . . 5133”. 2) On the list view of the tenant's list of invoices should have a column showing the type of payment and the last 4 digits of the card number. If the payment has been made with a check, the word “check” should be written along with the last 4 of the check number. If there is no card associated to the tenant, it should say “No card entered” but once a card is entered it should change to “visa . . . 5124”. If it was paid with a check, the message no card entered should change to check . . . 5133”. 3) On the add payment method screen there should also be a display of the current card used (last 4 digits) or it should say “no card entered” (See 3. Add payment method current card seen). 4) The general list view of all the tenants in a zone should also have a column titled payment method with the current payment method and the last 4 of the card or check number displayed. If there is no payment method selected, it should say in different coloring “needs payment method”. 5) The tenant's name and zone they belong to will be indicated on the top of the tenant's invoice.

In accordance with a thirty-fourth aspect, the system 100 may utilize ACH processes to account for payment.

In accordance with a thirty-fifth aspect, the system 100 may, via the portal 120, allow for the automatic or manual disabling of portal access due to lack of payment and/or restoration of access. In some embodiments, the Client Admin may lose the ability to log onto the portal 120 due to a failure to make payments.

In accordance with a thirty-sixth aspect, the system 100 may provide for making a credit for selected Tenants. In such embodiments, the credit may be communicated to the Tenant via electronic communications, e.g., emails, or on a statement of account accessible via the portal 120.

In accordance with a thirty-seventh aspect, the system 100 may provide for setting up of late fees for Tenants. In one example, a late fee may be set per Zone. This fee would get implemented into the calculation automatically if utilities are not paid by the “Pay Date”. Flat fee or bill percentage are two suitable examples of late fee options. Pay Date: Set up utilities pay date per tenant or per “unit”. This is used to act as a time marker that automatically initiates the “late fee” once that time has passed. The Client Admin assigns: Late Fee ($ / %), Days Until Late, and/or Zones (and children zones affected). In some embodiments, the system 100 may be implemented to apply a single late fee per invoice of a static amount defined by the Client Admin. This late fee is added to the line items on the unpaid invoice.

In accordance with a thirty-eighth aspect, the system 100 may enable the Client Admin to enter a unique fee or billing item. For example, via the portal, the Client Admin may add a fee for a special event or room, e.g., landscaping, party room, etc. Such fee may be added to any Zone, with or without reoccurrence.

In accordance with a thirty-ninth aspect, the system 100 may implement dynamic billing periods, e.g., different accounts can have their own billing periods set per account, or per Zone or Zone level.

In accordance with a fortieth aspect, the system 100 may implement direct billing of the Client Admin from the Super Admin. In such an aspect, the bill may include Primary Units that have tenants (and their total amount), secondary units that have tenants, primary units that have no tenants, and secondary units that have no tenants. This list may be viewable by the Client Admin via Grand Total of account, Total per property, total per building. Historical totals may also be accessible to the Client Admin and/or the Super Admin.

In accordance with a forty-first aspect, the system 100 may also provide direct billing of the Tenant by the Client Admin.

In accordance with a forty-second aspect, the system 100 may provide a Tenant payment status report to the Client Admin.

In accordance with a forty-third aspect, the system 100 may provide an illustration of water usage for non-Tenant Zones. This feature is for being able to associate meters that are installed but not in a tenant unit (example: to measure washing machines water usage, or separating out the landscaping water usage for possible utility bill reduction). The water usage report would then be visible to the Client Admin in a section of non-Tenant meters (With no need to pay). This feature also justifies the difference between what the tenants have paid and what the Client Admin owes to the Utility Company. While the water flow of these meters would be reported, there is no bill generated.

In accordance with a forty-fourth aspect, the system 100 may provide, via the portal 120, an ability of the Tenant to alter, update, or otherwise change the payment method. Such a change may also result in updates to the various Client Admin and Super Admin billing features.

In accordance with a forty-fifth aspect, the system 100 may utilize historical usage data received from a third party monitoring service regarding water usage. Current tenant usage data may be collected and used to modify the historical usage data to enable the system 100 to ascertain whether a leak is present based upon a combination of the historical and current usage data.

Some portions of the detailed description herein are presented in terms of algorithms and symbolic representations of operations on data bits performed by conventional computer components, including a central processing unit (CPU), memory storage devices for the CPU, and connected display devices. These algorithmic descriptions and representations are the means used by those skilled in the data processing arts to convey the substance of their work to others skilled in the art. An algorithm is generally perceived as a self-consistent sequence of steps leading to a desired result. The steps are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be understood, however, that all of these and similar terms are to be associated with the appropriate physical quantities and are merely convenient labels applied to these quantities. Unless specifically stated otherwise, as apparent from the discussion herein, it is appreciated that throughout the description, discussions utilizing terms such as “processing” or “computing” or “calculating” or “determining” or “displaying” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

The exemplary embodiment also relates to an apparatus for performing the operations discussed herein. This apparatus may be specially constructed for the required purposes, or it may comprise a general-purpose computer selectively activated or reconfigured by a computer program stored in the computer. Such a computer program may be stored in a computer readable storage medium, such as, but is not limited to, any type of disk including floppy disks, optical disks, CD-ROMs, and magnetic-optical disks, read-only memories (ROMs), random access memories (RAMs), EPROMs, EEPROMs, magnetic or optical cards, or any type of media suitable for storing electronic instructions, and each coupled to a computer system bus.

The algorithms and displays presented herein are not inherently related to any particular computer or other apparatus. Various general-purpose systems may be used with programs in accordance with the teachings herein, or it may prove convenient to construct more specialized apparatus to perform the methods described herein. The structure for a variety of these systems is apparent from the description above. In addition, the exemplary embodiment is not described with reference to any particular programming language. It will be appreciated that a variety of programming languages may be used to implement the teachings of the exemplary embodiment as described herein.

A machine-readable medium includes any mechanism for storing or transmitting information in a form readable by a machine (e.g., a computer). For instance, a machine-readable medium includes read only memory (“ROM”); random access memory (“RAM”); magnetic disk storage media; optical storage media; flash memory devices; and electrical, optical, acoustical or other form of propagated signals (e.g., carrier waves, infrared signals, digital signals, etc.), just to mention a few examples.

The methods illustrated throughout the specification, may be implemented in a computer program product that may be executed on a computer. The computer program product may comprise a non-transitory computer-readable recording medium on which a control program is recorded, such as a disk, hard drive, or the like. Common forms of non-transitory computer-readable media include, for example, floppy disks, flexible disks, hard disks, magnetic tape, or any other magnetic storage medium, CD-ROM, DVD, or any other optical medium, a RAM, a PROM, an EPROM, a FLASH-EPROM, or other memory chip or cartridge, or any other tangible medium from which a computer can read and use.

Alternatively, the method may be implemented in transitory media, such as a transmittable carrier wave in which the control program is embodied as a data signal using transmission media, such as acoustic or light waves, such as those generated during radio wave and infrared data communications, and the like.

The foregoing outlines features of several embodiments so that those skilled in the art may better understand the aspects of the present disclosure. Those skilled in the art should appreciate that they may readily use the present disclosure as a basis for designing or modifying other processes and structures for carrying out the same purposes and/or achieving the same advantages of the embodiments introduced herein. Those skilled in the art should also realize that such equivalent constructions do not depart from the spirit and scope of the present disclosure, and that they may make various changes, substitutions, and alterations herein without departing from the spirit and scope of the present disclosure.

1. An apparatus configured for water usage monitoring and meter health, comprising:
one or more memories comprising processor-executable instructions; and
one or more processors configured to execute the processor-executable instructions and cause the apparatus to:
receive measurement data corresponding to water usage from an associated meter device over a communications network;
analyze the received measurement data to determine at least one property associated with the water usage;
generate a graphical user interface depicting the at least one property associated with the water usage in accordance with the analysis; and
selectively communicate the generated graphical user interface to a client device.

2. The apparatus of claim 1, wherein the measurement data includes a measurement of water flow.

3. The apparatus of claim 2, wherein the one or more processors are configured to execute the processor-executable instructions and further cause the apparatus to:
receive historical water usage data from an external source; and
compare the received historical water usage data with the received measurement data.

4. The apparatus of claim 3, wherein the one or more processors are configured to execute the processor-executable instructions and further cause the apparatus to:
determine a leak is present in accordance with a result of the comparing of the received historical water usage data with the received measurement data.

5. The apparatus of claim 4, wherein to selectively communicate the generated graphical interface to the client device, the one or more processors are configured to execute the processor-executable instructions and further cause the apparatus to:
generate an electronic communication alert in response to the determination that a leak is present; and
send the generated electronic communication alert to the client device.

6. The apparatus of claim 4, wherein to selectively communicate the generated graphical interface to the client device, the one or more processors are configured to execute the processor-executable instructions and further cause the apparatus to:
determine a backflow is present in accordance with a result of the comparing of the received historical water usage data with the received measurement data;
generate an electronic communication alert in response to the determination that a backflow is present; and
send the generated electronic communication alert to the client.

7. The apparatus of claim 1, wherein the measurement data includes health data corresponding to the associated meter.

8. The apparatus of claim 7, wherein the health data includes a battery level of the associated meter.

9. The apparatus of claim 8, wherein the one or more processors are configured to execute the processor-executable instructions and further cause the apparatus to:
generate an alert when the battery level of the associated meter is below a predetermined level; and
communicate the generated alert to the client device

10. The apparatus of claim 7, wherein the health data includes a signal strength.

11. The apparatus of claim 10, wherein the one or more processors are configured to execute the processor-executable instructions and further cause the apparatus to:
generate an alert responsive to a signal strength below a predetermined level; and
communicate the generated alert to the client device.

12. An method for water usage monitoring and meter health, comprising:
receiving measurement data corresponding to water usage from an associated meter device over a communications network;
analyzing the received measurement data to determine at least one property associated with the water usage;
generating a graphical user interface depicting the at least one property associated with the water usage in accordance with the analysis; and
selectively communicating the generated graphical user interface to a client device.

13. The method of claim 11, wherein the measurement data includes a measurement of water flow.

14. The method of claim 13, further comprising:
receiving historical water usage data from an external source; and
comparing the received historical water usage data with the received measurement data.

15. The method of claim 14, further comprising:
determining a leak is present in accordance with a result of the comparing of the received historical water usage data with the received measurement data;
generating an electronic communication alert in response to the determination that a leak is present; and
sending the generated electronic communication alert to the client device.

16. The method of claim 14, further comprising:
determining a backflow is present in accordance with a result of the comparing of the received historical water usage data with the received measurement data;
generating an electronic communication alert in response to the determination that a backflow is present; and
sending the generated electronic communication alert to the client.

17. The method of claim 12, wherein the measurement data includes health data corresponding to the associated meter.

18. The method of claim 17, wherein the health data includes a battery level of the associated meter, the method further comprising:
generating an alert when the battery level of the associated meter is below a predetermined level; and
communicating the generated alert to the client device.

19. The method of claim 17, wherein the health data includes a signal strength, the method further comprising:
generating an alert responsive to a signal strength below a predetermined level; and
communicating the generated alert to the client device.

20. One or more non-transitory computer-readable media comprising executable instructions that, when executed by one or more processors of an apparatus, cause the apparatus to perform operations comprising:
receiving measurement data corresponding to water usage from an associated meter device over a cellular communications network;
analyzing the received measurement data to determine at least one property associated with the water usage;
generating a graphical user interface depicting the at least one property associated with the water usage in accordance with the analysis; and
selectively communicating the generated graphical user interface to a client device.
